(19) United States
(12) Patent Application Publication
(10) Pub. No.: US 2014/0314571 A1
(43) Pub. Date: Oct. 23, 2014

(54) CEILING LIGHT ASSEMBLY

(71) Applicant: W. K. WU PRODUCTS INC., NEW TAIPEI CITY (TW)

(72) Inventor: WILSON WU, TAIPEI CITY (TW)

(73) Assignee: W. K. WU PRODUCTS INC., NEW TAIPEI CITY (TW)

(21) Appl. No.: 13/868,850

(22) Filed: Apr. 23, 2013

(51) Int. Cl. F21V 33/00

(52) U.S. Cl. CPC F21V 33/0096
USPC 416/5

(57) ABSTRACT

A ceiling light assembly which comprises: a main body comprising (a) an upper shell developing an upper shell space inside and one group of suction holes at its surface and (b) a lower shell on which a lower through hole is centrally opened; a fan unit held in the upper shell space and comprising at least a fan body and an airflow tube to which the fan body is connected wherein the airflow tube is a hollow ringlike tube developing an air passage internally and having an air outlet which faces downward being away from the fan body and linking said air passage; a lighting unit installed in the main body to realize the hidden fan unit which is integrated with the lighting unit.

### BACKGROUND OF THE INVENTION

1. Field of the Invention

The present invention relates to a light assembly, particularly a ceiling light assembly which combines a hidden fan unit, supplies unobstructed airflows to circulate air in an interior space, and features texture perception.

2. Description of the Related Art

Both lamps and fans inducing air-conditioning flows have become indispensable appliances in modern people's lives: lamps installed high in a building such as ceilings and walls give out light over a wide range; indoor fans inducing air-conditioning flows and hung high to diffuse airflows over a large area. As a mainstream application in the future, an assembly with combination of fans and lamps contributes to not only functionality but also space saving. FIG. 1 illustrates China Patent Application No. 201110439388 which presents a ceiling fan 90 comprising an airflow segment 91 and a nozzle 92: the airflow segment 91 is internally provided with a motor by which airflows to be delivered to the nozzle 92 are generated and is connected to a support unit 93 by which the ceiling fan 90 is fixed on a ceiling; the nozzle 92 is ring-like body from which airflows are diffused. The prior art for a fan fixed on a ceiling and not exposed outside (China Patent Application No. 201110439388) has limited functions because of no lighting device integrated into the fan.

FIG. 2 illustrates China Patent Application No. 93226697.5 which presents a modular ceiling fan light 100 comprising a bulb shell 101, a motor 102 centrally installed on the bulb shell 101, a hanger rod 103 connected to the motor 102 and used to support the modular ceiling fan light 100 on a ceiling, a fan 104 sheltered by the bulb shell 101 and activated by the motor 102, a lamp 105 installed under the fan 104, and an air passage baffle 106 situated between the lamp 105 and the bulb shell 101 and diffusing airflows by separating the fan 104. The prior art for a ceiling fan light (China Patent Application No. 93226697.5) fulfilling both illumination and air-conditioning flows but still has some drawbacks. For example, the fan 104 rotating in the modular ceiling fan light 100, which is hung on a ceiling could only deliver of unidirectional airflows. Also the fan 104 is separated by the air passage baffle 106 could still be observed by user and cause visual stress after a period of time the air passage baffle 106, which blocks and dissipates airflows, induces vibrations and noise, is also difficult to clean because of limited space. This is an inadequate design and need to be corrected. Therefore, the abovementioned drawbacks in the prior art for a ceiling fan light deserve to be overcome by persons skilled in the art.

Having considered imperfect structural design and drawbacks of the prior art for a ceiling fan light, the inventor has come up with a solution that would solve and optimized construction. The solution is a ceiling light assembly featuring hidden fans, the fan redirect and concentrates airflows that help circulate air in a room or any other interior setting. The inventor has studied and developed the present invention to be easy operation, easy to clean, space saving and contemporary design.

### SUMMARY OF THE INVENTION

The object of the present invention is to provide an assembly which combines a lighting unit and a hidden fan unit that features neither visual stress nor noise.

The other object of the present invention is to provide an assembly whose fan unit diffuses concentrated airflows to circulate air in a room, design for easy operation and cleaning; the invention also has better practicability and texture perception.

The present invention is based on the following technical measures to realize the above purposes: a main body comprising (a) an upper shell developing an upper shell space inside and one group of suction holes at its surface and (b) a lower shell on which a lower through hole is centrally opened; a fan unit held in the upper shell space which comprising at least a fan body and an airflow tube to which the fan body is connected. The airflow tube is a hollow ring-like shape developing an air passage internally and having an air outlet which faces downward being away from the fan body and linking said air passage; a lighting unit comprising a baseboard and a plurality of LED bulbs installed on the baseboard; an electronic control unit connected to the baseboard to control the lighting unit.

The present invention is also based on further technical measure to realize the above purposes: the airflow tube has at least one air passage adapters, each of which has an intake port and flow deflectors at the opening that divide the intake port into several compartments. The flow deflectors direct air evenly inside the air passage.

The present invention is also based on yet a further technical measure to realize the above purposes: between the air passage adapters, there are partitions installed at opposite ends inside the air passage creating two independent compartments; where each fan body is responsible to provide air flow to each of the compartment. The partitions are only installed when there are more than one fan bodies in the setup.

For technical features, function and accompanying drawings of the invention are thoroughly described hereinafter.

### BRIEF DESCRIPTION OF THE DRAWINGS

FIG. 1 is a schematic view of a fan assembly based on the prior art.

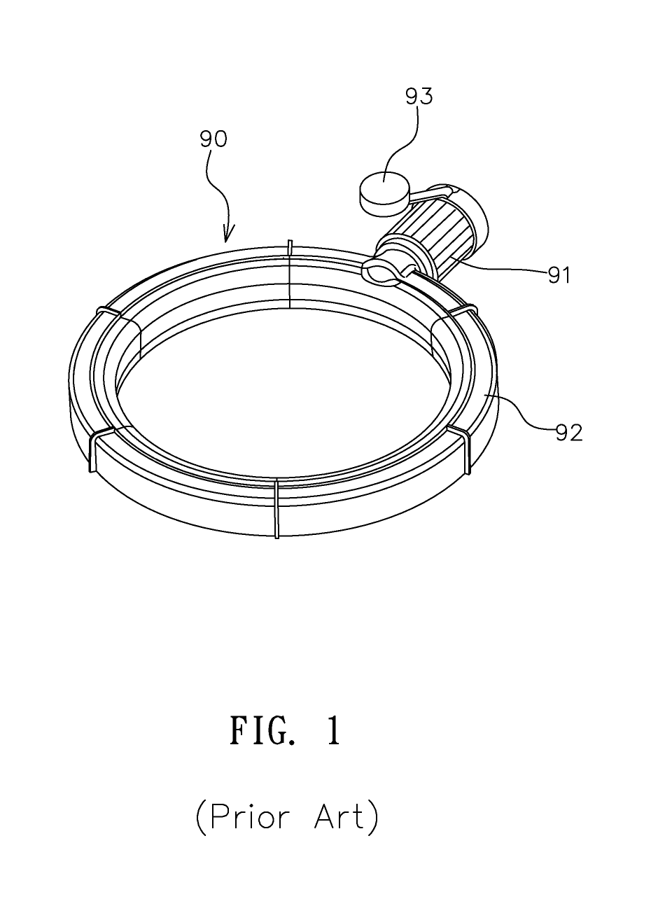

FIG. 2 is a schematic view for a ceiling fan light based on the prior art.

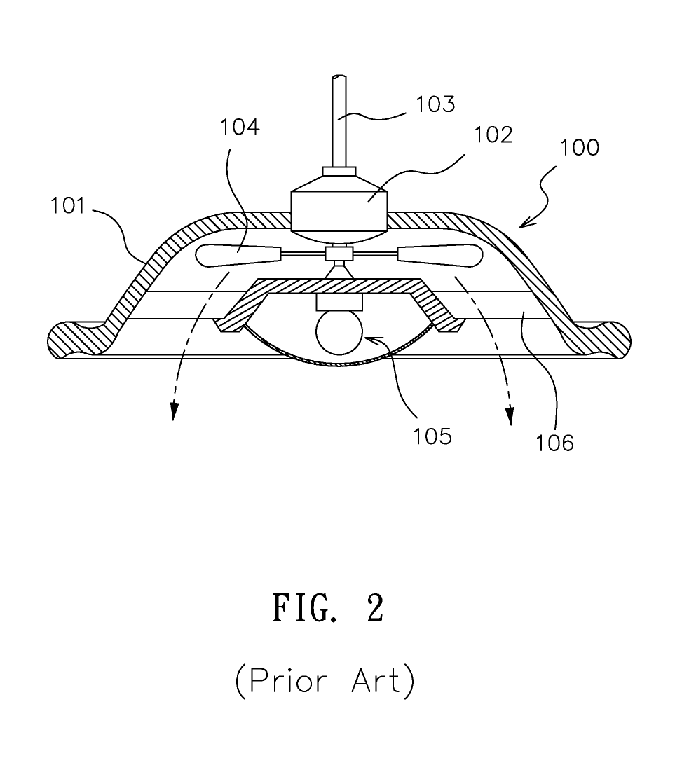

FIG. 3 is a perspective view of the present invention which has been assembled.

FIG. 4 is an exploded view of the present invention.

FIG. 5 is a partial section view illustrating an upper shell assembled onto a lower shell in the present invention.

FIG. 6 is a partial exploded view of the present invention.

FIG. 7 is a partial section view for an air passage in the present invention.

FIG. 8 is a perspective view for an air passage in the present invention.

FIG. 9 is a schematic view of the present invention to be assembled.

FIG. 10 is a section view of the present invention which has been assembled.

FIG. 11 is a partial enlargement view of the present invention which has been assembled.

### DETAILED DESCRIPTION OF THE PREFERRED EMBODIMENTS

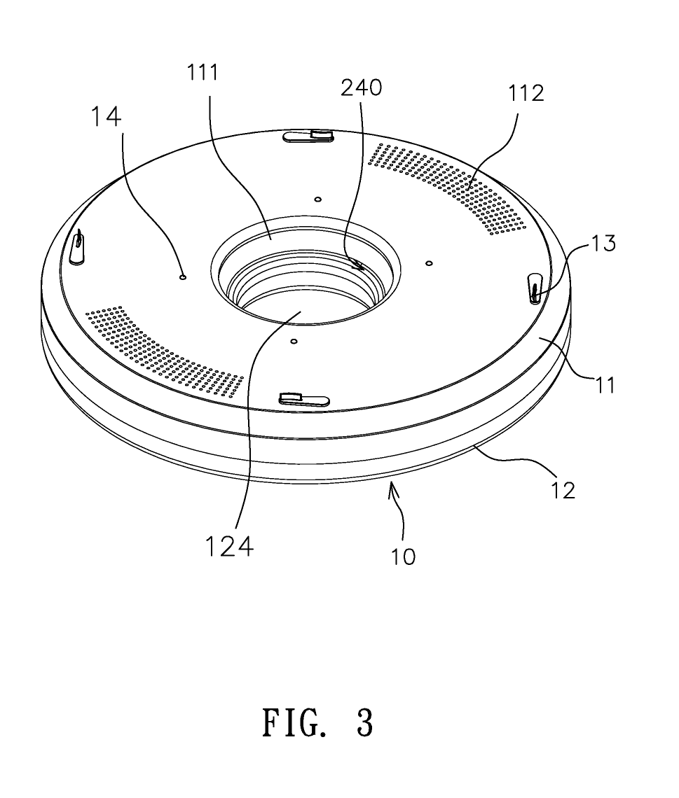

Referring to FIGS. 3, 4, and 5 which illustrate the present invention of a ceiling light assembly, particularly the ceiling light assembly comprising a main body 10, a hidden fan unit 20, a lighting unit 30 and a control unit 40.

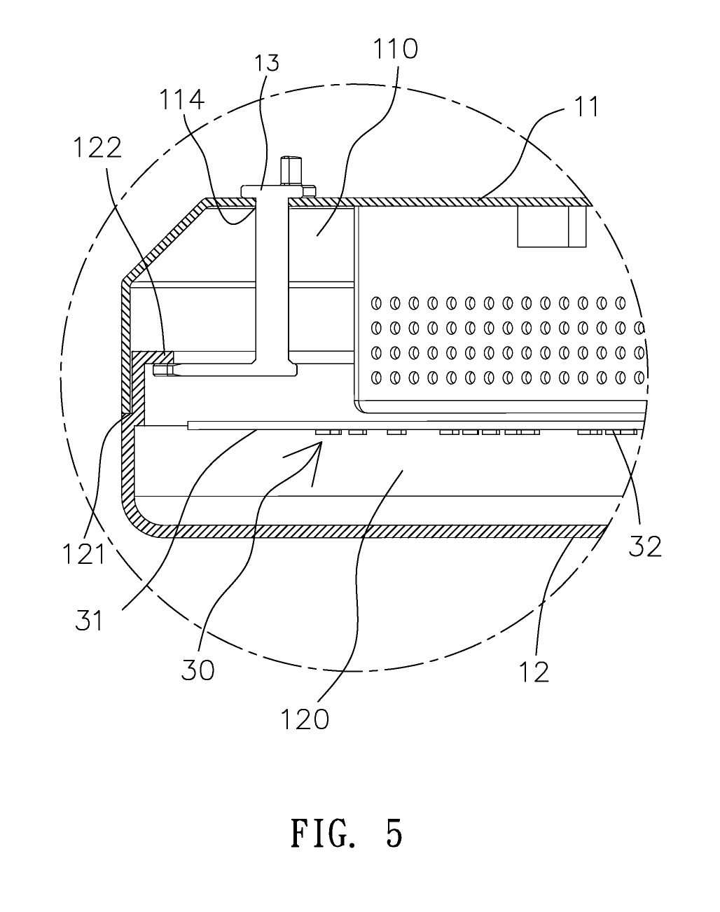

The main body 10 comprises an upper shell 11 and a lower shell 12 (both of which refer to orientations in FIGS. 3, 4, and 5): the upper shell 11 which is a disk-shaped component (or a. component with another shape) comprises an upper shell space 110 inside, an upper through hole 111, suction holes 112 (numbers of suction holes 112 may varies), and pilot holes 113, 114 at its top surface, the suction hole 112 consists of many apertures; the lower shell 12 assembled onto the bottom of the upper shell 11 to become a sealed shell body. The lower shell 12 comprises (a) a lower shell space 120 inside, (b) a flanged ring 123, (c) a lower through hole 124 surrounded by the flanged ring 123 and opened on the lower shell 12, (d) a joining ring 121 peripherally arranged at the outer edge of the lower shell 12 and is used in assembling the upper shell 11, and (c) a convex rib 122 peripherally arranged at the inner edge of the lower shell 12 and extending inward; the upper shell 11 and the lower shell 12 are assembled with fasteners 13 (or other fastening components). The fastener 13 is first installed on to upper shell 11 through pilot hole 114, after upper shell 11 and lower shell 12 are assembled, the fastener 13 are turned and snap into place to secured at convex rib 122 (FIG. 5). The upper shell 11 could be manufactured with transparent or non-transparent material.

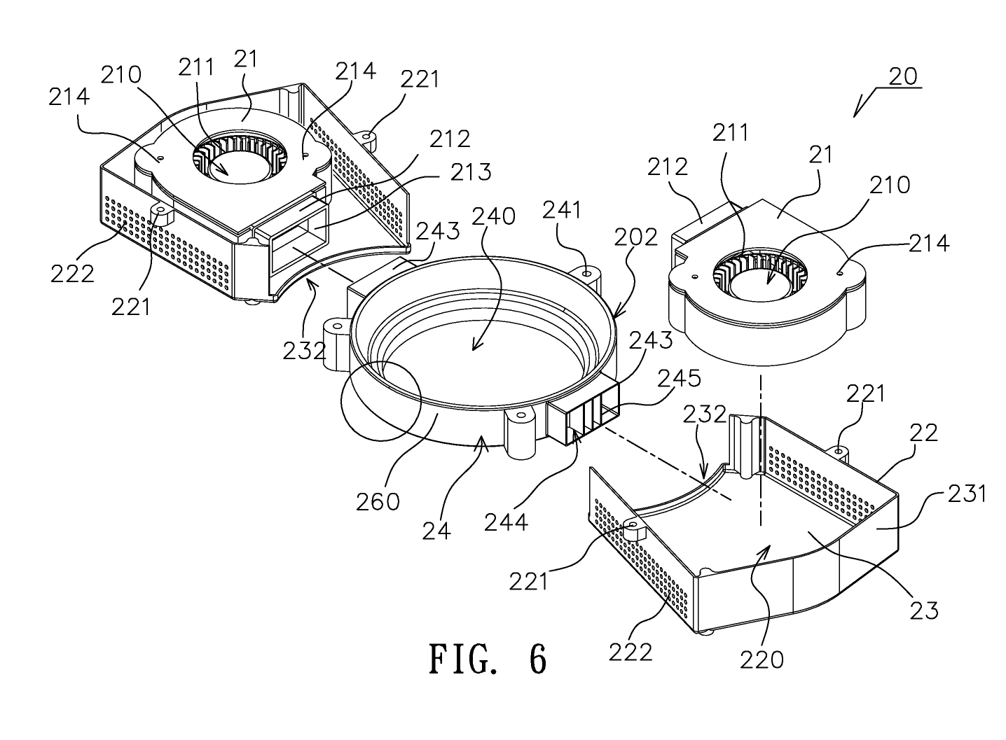

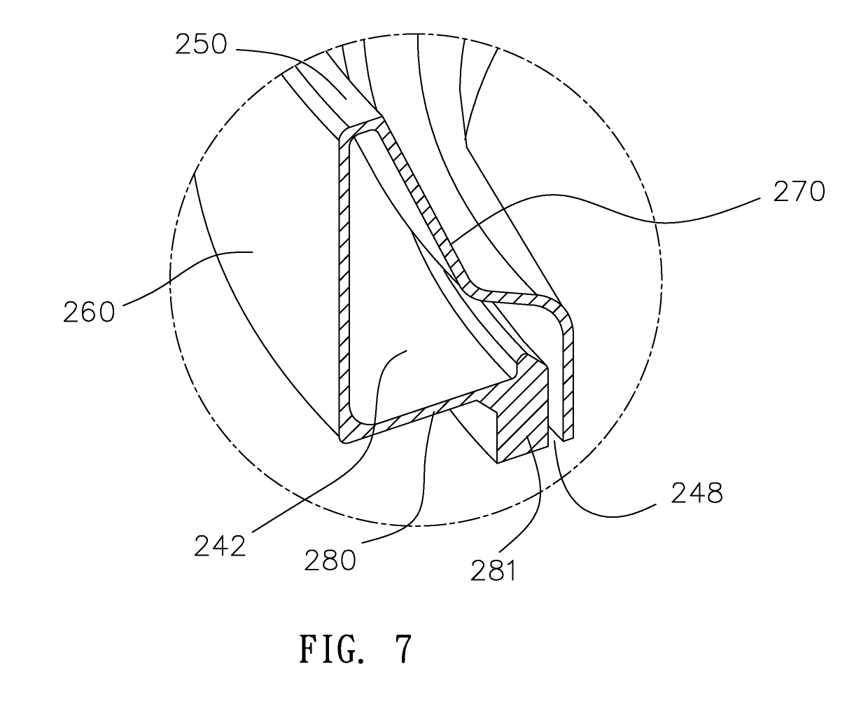

Referring to FIGS. 6 and 7 which illustrate the fan unit 20 comprises fan bodies 21 (two units of fan bodies in this embodiment but number of fan bodies is not restricted) and an airflow tube 24: each of the fan bodies 21 comprises an air intake 210 centrally, a plurality of vanes 211 inside, and a fan adapter 212 internally developing a fan exhaust 213 that corresponds to one side of the airflow tube 24; the airflow tube 24 is a hollow ring-like tube(or other shape) linking to one side of the fan body 21. The airflow tube 24 has a through circular port 240 centrally, that is, the airflow tube 24 is a hollow ring-like tube with the circular port 240 in the center; the airflow tube 24 develops an air passage 242 (FIG. 7) internally, along with air passage adapters 243 at both sides. Each of the air passage adapters 243 has an intake port 244.

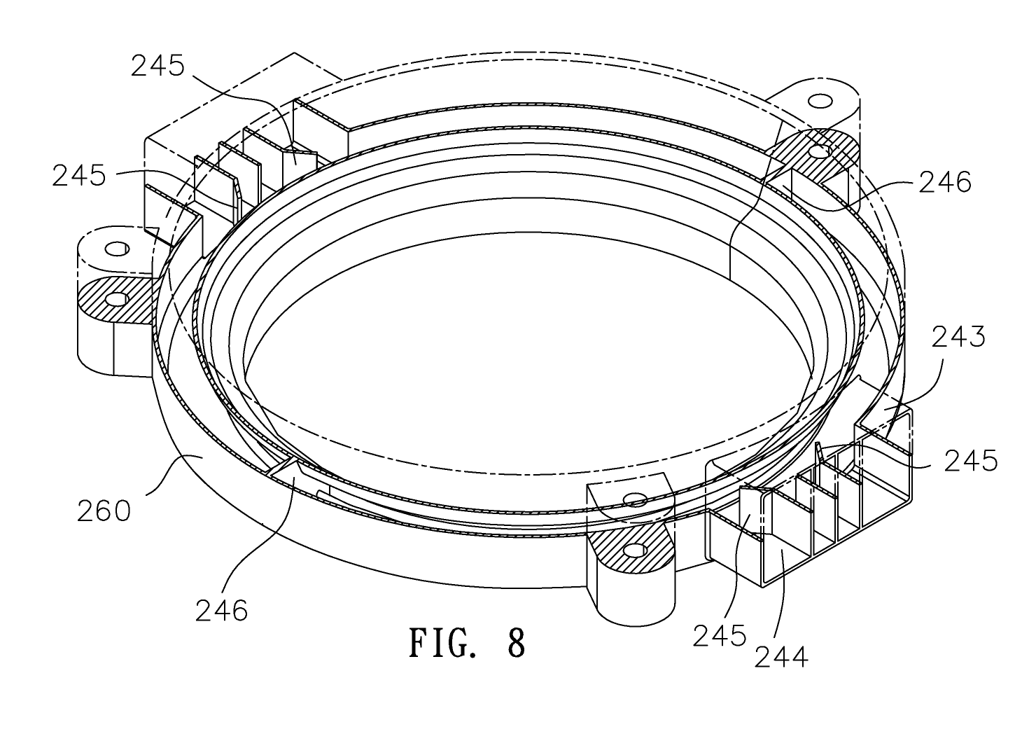

Referring to FIG. 8 that illustrates the intake port 244 in which flow deflectors 245 (perpendicular to airflows' direction) are further designed. As such, the intake port 244 is divided into several compartments by the flow deflectors 245 and links to the air passage 242; the airflow tube 24 is provided with a plurality of joint components 241, each of which is similar to a lug with a hole thereon, and securely connected to the upper shell 11 (at the pilot holes 113) by joining bolts 14 and the joint components 241.

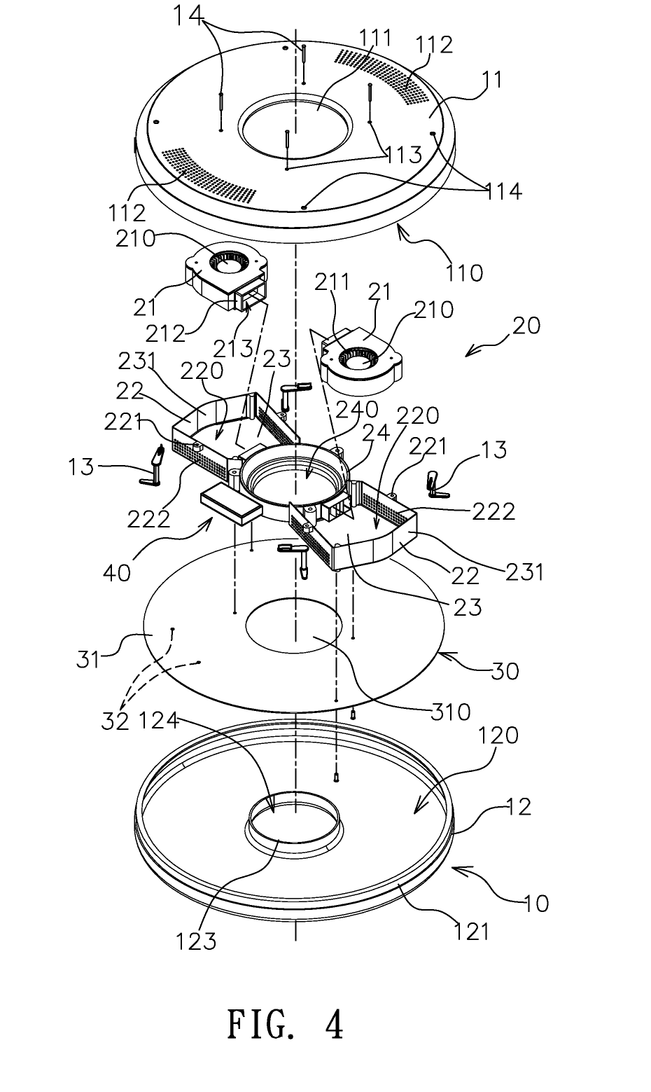

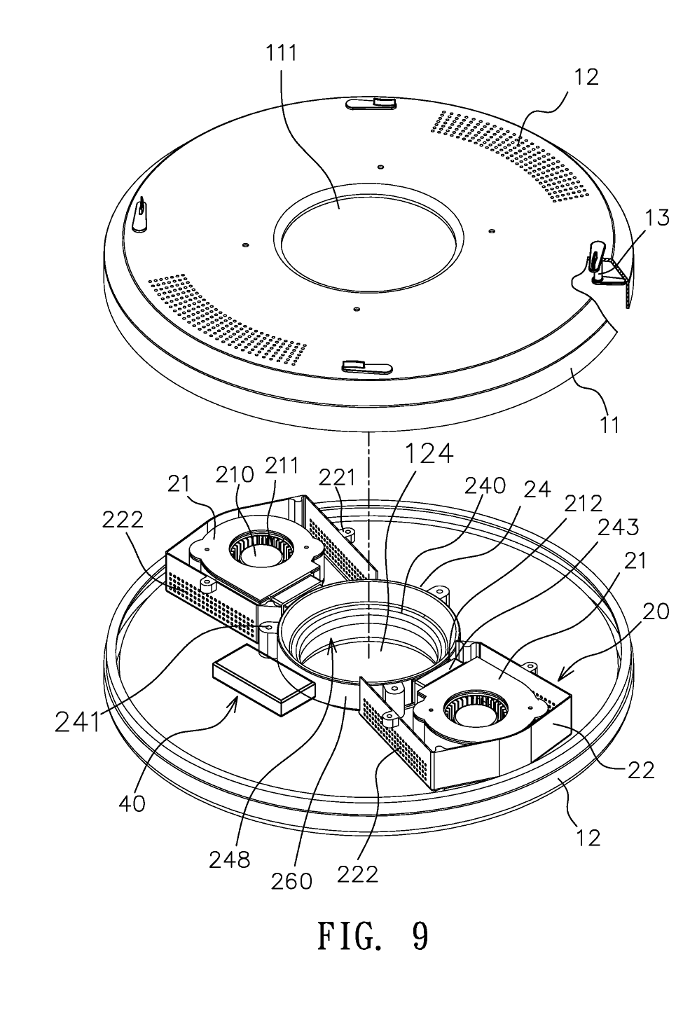

Referring to FIG. 9 which illustrates the fan bodies 21 are fixed Co the upper shell 11 but preserved a gap for unobstructed airflows. Moreover, the airflow tube 24 allows the circular port 240 to align both the upper through hole 111 on the upper shell 11 and the lower through hole 124 on the lower shell 12 (FIG. 4); the air passage adapters 243 is connected to the fan adapters 212 on the fan bodies 21 to make connections between the intake ports 244 on both sides of the airflow tube 24 and the fan exhausts 213 on the fan bodies 21. As shown in FIGS. 4 and 6, each of the two fan bodies 21 is held in a silencer 22 in which there is an accommodation space 220 designed for the fan body 21. The silencer 22 comprises a baseplate 23, three contiguous side panels 231 around the baseplate 23, and an opening 232: at least one of the side panels 231 comprises a plurality of inlet holes 222 and at least a joint component 221 (one component similar to a lug) on which there is a hole penetrated by a bolt (not shown in figures) for fixing the silencer 22 on the upper shell 11; the opening 232 corresponding to the air passage adapter 243 (intake port 244) on the airflow tube 24 facilitates connection between the fan body 21 and the airflow tube 24. When assembled, opening 232 is attached to the airflow tube 24 as shown in FIG. 9.

As shown in FIGS. 4, 5, the lighting unit 30 comprises a baseboard 31 and a plurality of LED bulbs 32 thereon: the baseboard 31 is a printed circuit board on which a through hole 310, a hole with a round or another shape matching the airflow tube 24, is centrally opened, and is also a circular board adapted to the main body 10 in this embodiment; the LED bulbs 32 installed on the reverse side of the baseboard 31 are used to project light through the transparent material of the lower shell 12. Furthermore, the control unit 40 installed on and electrically connected to the baseboard 31 is used to control the lighting unit 30 (the LED bulbs 32). The control unit 40 is also electrically connected to the fan unit 20 for enabling/disabling the fan unit 20 and deciding RPMs thereof; the control unit 40 could also be enable to receive commends from smartphone or similar devices with installed application.

Referring to FIGS. 6 and 7 which illustrate the airflow tube 24 comprises an external tube wall 260, an internal tube wall 270, a lower tube wall 280 and an upper tube wall 250; the air passage adapters 243 protrude from the external tube wall 260; the lower tube wall 280 develops a protuberance 281 abutting the internal tube wall 270 and bending downward. The external tube wall 260, the internal tube wall 270, the lower tube wall 280 and the upper tube wall 250 together develop the air passage 242 in between; the internal tube wall 270 is a continuous wave-shaped wall body tapering toward the circular port 240 of the airflow tube 24; the internal tube wall 270 has one end linking the upper tube wall 250 and the other end extending toward but properly separated from the protuberance 281 of the lower tube wall 280 for development of an air outlet 248 facing downward and linking the intake port 244 and the air passage 242, In other words, the airflow tube 24 has the air outlet 248 is situated inside airflow tube 24 at one end which faces downward being away from the fan body

Referring to FIG. 8 which illustrates the present invention is further internally provided with a number of partitions 246 (two partitions 246 in this embodiment) between the air passage adapters 243 for development of two separate and discontinuous compartments inside the airflow tube 24 and each fan body 21 is responsible to provide air flow to each of the separate compartment.

Referring to FIGS. 9, 10 and 11 which illustrate the present invention of a ceiling light assembly wherein the flanged ring 123 on the lower shell 12 is inserted into both the through hole 310 on the baseboard 31 and the circular port 240 on the airflow tube 24 from the bottom up and allows its top end of the flanged ring 123 to be situated under the air outlet 248 and contact the protuberance 281 on the lower tube wall 280, that is, the flanged ring 123 does not cover the air outlet 248; the LED bulbs 32 project light through the lower shell 12; the fan unit 20 (fan bodies 21) sheltered by the baseboard 31 and the flanged ring 123 is totally concealed and dramatically reduce noise induced by the running fan bodies 21 which are held in the silencers 22.

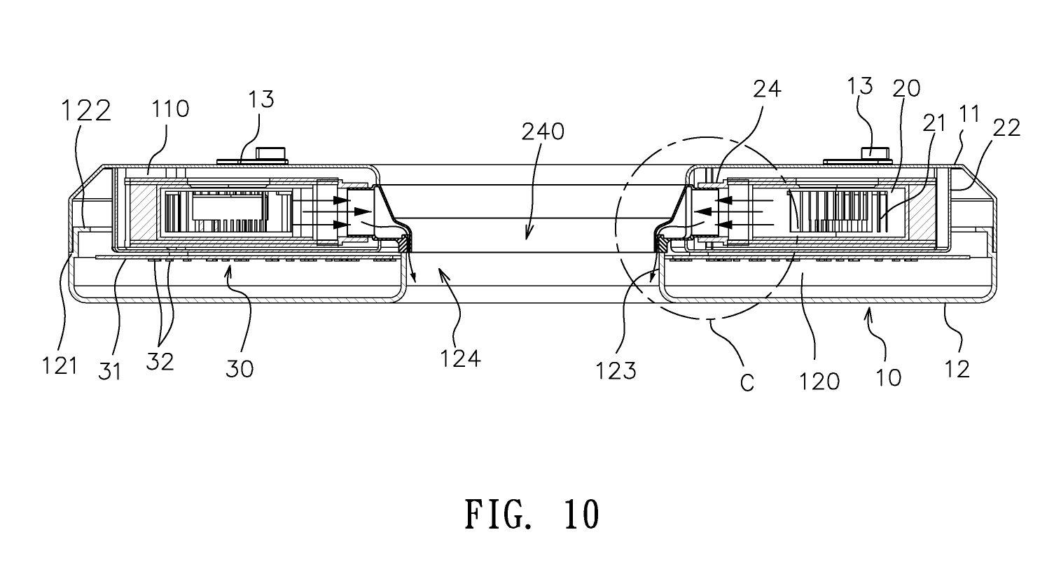

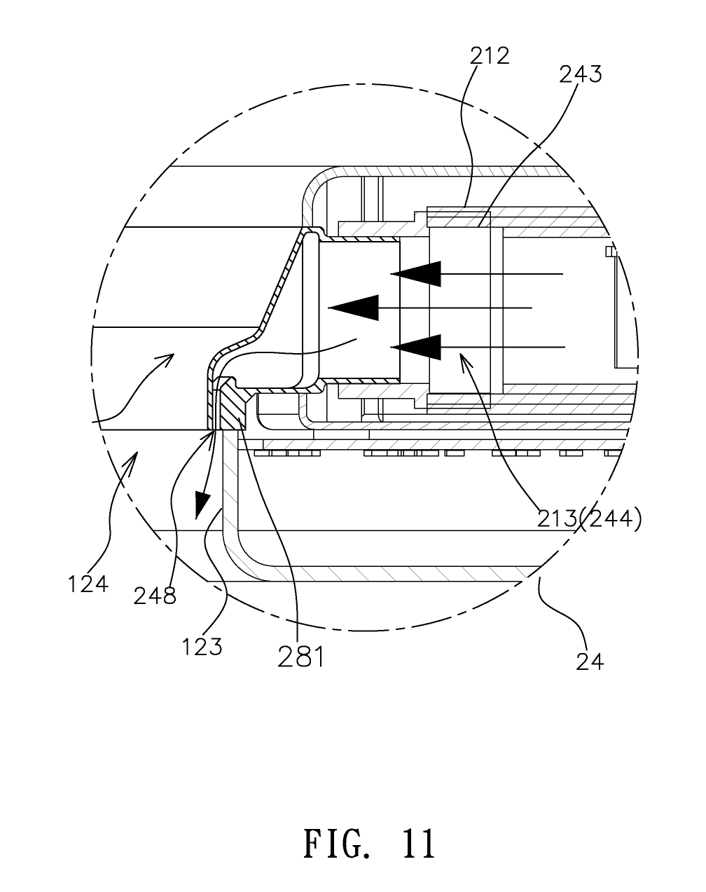

In the present invention of a ceiling light assembly to be used, a proper gap for external airflows is kept between the top surface of the upper shell 11 and a ceiling (not shown in figures) on which the upper shell 11 is fixed: airflows (atmosphere) through the suction holes 112 on the top and peripheral surfaces of the upper shell 11 are drawn into the upper shell space 110, air flown into the silencers 22 via the inlet holes 222, and pressurized by the fan bodies 21 through the air intakes 210 when the fan bodies 21 are activated. Referring to FIGS. 10 and 11 which illustrate airflow channels including the fan exhausts 213 of the fan bodies 21, the intake ports 244 on the airflow tube 24, the air passage 242, and the air outlet 248, all of which are connected. As such, airflows induced by the running fan bodies 21 are pushed out from the air outlet 248; more air around the upper through hole 111 on the central top of the upper shell 11 is absorbed via the circular port 240 and direct through the lower through hole 124. The ability to absorb more air from upper through hole 111 means there is more air been pushed down than just air generated from fan body 21.

It can be seen from above disclosures that the present invention of a ceiling light assembly with hidden fans integrated features of neither visual stress nor noise. It diffuses concentrated airflows, and facilitates easy cleaning, practicability and contemporary design.

Moreover, the present invention with a wall-mounted lighting unit and hidden fans integrated can be fixed on a wall in operation.

Accordingly, the present invention significantly meets patentability and is applied for the patent. The above descriptions are only preferred embodiments which do not limit the scope of the present invention; any equivalent change or improvement without departing from spirit of the present invention should be incorporated in claims herein.

What is claimed is:

1. A ceiling light assembly, comprising:
a main body comprising an upper shell and a lower shell, both of which are assembled: upper shell develops an upper shell space inside and at least a group of suction holes on the surface of upper shell, said suction hole consists of many apertures, and said lower shell has a lower through hole centrally;
a fan unit held in said upper shell space, comprising at least a fan body and an airflow tube to which the fan body is connected with the airflow tube: said airflow tube is a hollow ringlike tube developing an air passage internally and having an air outlet which faces downward and away from said fan body, said air outlet and said air passage are internally linked;
a lighting unit comprising a baseboard and a plurality of LED bulbs installed on the baseboard's reverse side;
a control unit electrically connected to the baseboard for controlling said lighting unit.

2. The ceiling light assembly according to claim 1 wherein upper shell has an upper through hole centrally.

3. The ceiling light assembly according to claim 1 wherein lower shell develops a lower shell space inside and a flanged ring centrally for development of lower through hole opened on lower shell.

4. The ceiling light assembly according to claim 1 wherein said upper shell and said lower shell, both of which are assembled with fasteners or other fastening components.

5. The ceiling light assembly according to claim 3 wherein fan body installed at one side of airflow tube comprises an air intake, a plurality of vanes inside, and a fan adapter corresponding to one side of airflow tube, which the fan adapter internally developing a fan exhaust linking the air intake.

6. The ceiling light assembly according to claim 1 wherein the airflow tube develops a through circular port centrally and at least an air passage adapter at one side, said air passage adapter has an intake port linking the air passage which also aligns the fan adapter for connecting the intake port and the fan exhaust together.

7. The ceiling light assembly according to claim 6 wherein the intake port develops flow deflectors therein to separate the intake port into several compartments.

8. The ceiling light assembly according to claim 5 wherein the circular port aligns the upper through hole and the lower through hole.

9. The ceiling light assembly according to claim 1 wherein said fan unit further comprises a silencer which is used to accommodate said fan body. The silencer comprises a baseplate, three contiguous side panels around said baseplate, and an opening: at least one of said side panels comprises a plurality of inlet holes and at least a joint component with a hole, said joint component is screwed onto to said upper shell; said opening corresponds to said air passage adapter of said airflow tube and allows said side panels at both sides to fit the shape of said airflow tube.

10. The ceiling light assembly according to claim 1 wherein the baseboard is a printed circuit board on which there is a through hole in the center.

11. The ceiling light assembly according to claim 3 wherein the airflow tube comprises an external tube wall, an internal tube wall, a lower tube wall and an upper tube wall for development of the air passage in between.

12. The ceiling light assembly according to claim 11 wherein the. lower tube wall develops a protuberance abutting said internal tube wall and bending downward and the flanged ring allows its top end to be situated under the air outlet and contact the protuberance on the lower tube wall.

13. The ceiling light assembly according to claim 11 wherein the internal tube wall is a continuous wave-shaped wall body tapering toward the circular port of the airflow tube.

14. The ceiling light assembly according to claim 11 wherein the internal tube wall has its one end linking the upper tube wall and other end extending toward the protuberance on the lower tube wall until a proper gap between the internal tube wall and the protuberance in order to develop said air outlet facing downward.

15. The ceiling light assembly according to claim 1 wherein the airflow tube is further provided with partitions between the air passage adapters for development of separate compartments inside the airflow tube and each said fan body is responsible to provide airflow to each of said separate compartment.
